(19) United States
(12) Patent Application Publication
(10) Pub. No.: US 2016/0154432 A1
(43) Pub. Date: Jun. 2, 2016

(54) DETACHABLE ELECTRONIC DEVICE

(71) Applicants: Inventec (Pudong) Technology Corporation, Shanghai (CN); INVENTEC CORPORATION, Taipei (TW)

(72) Inventors: Yu-Chi Lin, Taipei (TW); Kuan-Yao Lee, Taipei (TW); Chun-Yuan Huang, Taipei (TW); Tse-Min Wang, Taipei (TW)

(21) Appl. No.: 14/688,266

(22) Filed: Apr. 16, 2015

(30) Foreign Application Priority Data
Nov. 27, 2014 (CN) 201410707556.4

(51) Int. Cl. G06F 1/16

(52) U.S. Cl. CPC G06F 1/1637; G06F 1/1626; G06F 1/1667

(57) ABSTRACT

A detachable electronic device includes an input module, a flexible connecting module and a display module. The input module has a signal input part. The flexible connecting module is connected to the input module. The display module is electrically connected to the input module, and has a display part and a slot located at a peripheral of the display part. The flexible connecting module is detachably assembled with the display module via the slot, and for supporting the display module. When the flexible connecting module is bent by an external force, the display module is driven to rotate relative to the input module, and a tilt angle of the display module is changed relative to the input module.

### CROSS-REFERENCE TO RELATED APPLICATIONS

This non-provisional application claims priority under 35 U.S.C. §119(a) on Patent Application No(s). 201410707556.4 filed in China on Nov. 27, 2014, the entire contents of which are hereby incorporated by reference.

### BACKGROUND

1. Technical Field

The disclosure relates to a detachable electronic device. More particularly, the disclosure relates to a detachable electronic device comprising a flexible connecting module disposed through a display module of the detachable electronic device.

2. Background

Personal computers (PC) can be classified into a desktop computer, a laptop computer (namely, notebook computer) or a tablet computer. Since the desktop computer is large and heavy, the desktop computer is usually for home use. The laptop computer is smaller than the desktop computer, and is easily portable for users to carry to different places. In recent years, since the touch technology has been developed to combine the display function with the input function of the PC, and a new design concept has been established to make the PC become smaller in size and lighter in weight, the tablet computer has developed to be miniaturized. Thus, the tablet computer usually comprises a touch input module, the users can use the touch input module to input some electronic signals to the tablet computer.

Compared to the laptop computer, the tablet computer is more convenient for the users to carry around with them. However, a touch input module of the tablet computer is not as convenient as the keyboard when the users input the electronic signals into the tablet computer. Accordingly, a tablet computer with a detachable keyboard has been developed. However, the detachable keyboard of the tablet computer is merely plugged into the display screen; it is similar to the configuration of the laptop computer, and there are no other operation modes offered to the users.

Hence, an electronic device needs to be developed for users to operate with different kinds of operation modes.

### SUMMARY

One aspect of the disclosure provides a detachable electronic device which comprises an input module, a flexible connecting module and a display module. The input module has a signal input part. The flexible connecting module is connected to the input module. The display module is electrically connected to the input module, and has a display part and a slot located at a peripheral of the display part. The flexible connecting module is detachably assembled with the display module via the slot, and for supporting the display module. When the flexible connecting module is bent by an external force, the display module is driven to rotate relative to the input module, and a tilt angle of the display module is changed relative to the input module.

### BRIEF DESCRIPTION OF THE DRAWINGS

The disclosure will become more fully understood from the detailed description given herein-below and the accompanying drawings which are given by way of illustration only and thus are not limitative of the disclosure, and wherein:

FIG. 1A is a perspective front view of a detachable electronic device according to an embodiment of the disclosure;

FIG. 1B is a perspective rear view of the detachable electronic device in FIG. 1A;

FIG. 2 is an exploded view of a flexible connecting module in FIG. 1A;

FIG. 3 is a top view of the detachable electronic device when being in a tablet mode of operation;

FIG. 4A and FIG. 4B are side views of the detachable electronic device when being in a laptop mode of operation;

FIG. 5 is a perspective rear view of the detachable electronic device when being in a viewing mode of operation; and

FIG. 6 is a side view of the detachable electronic device when being in a portable mode.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

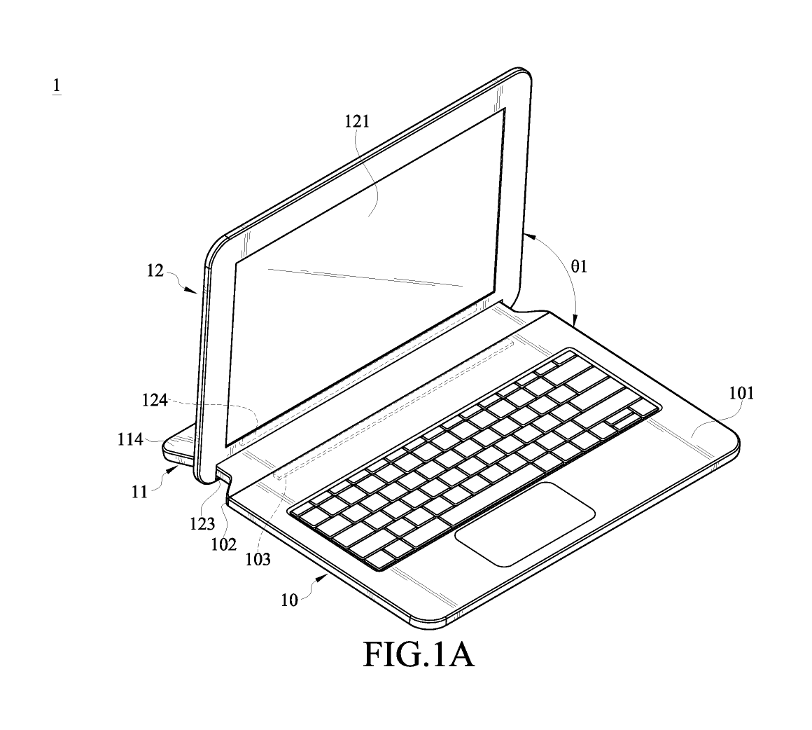

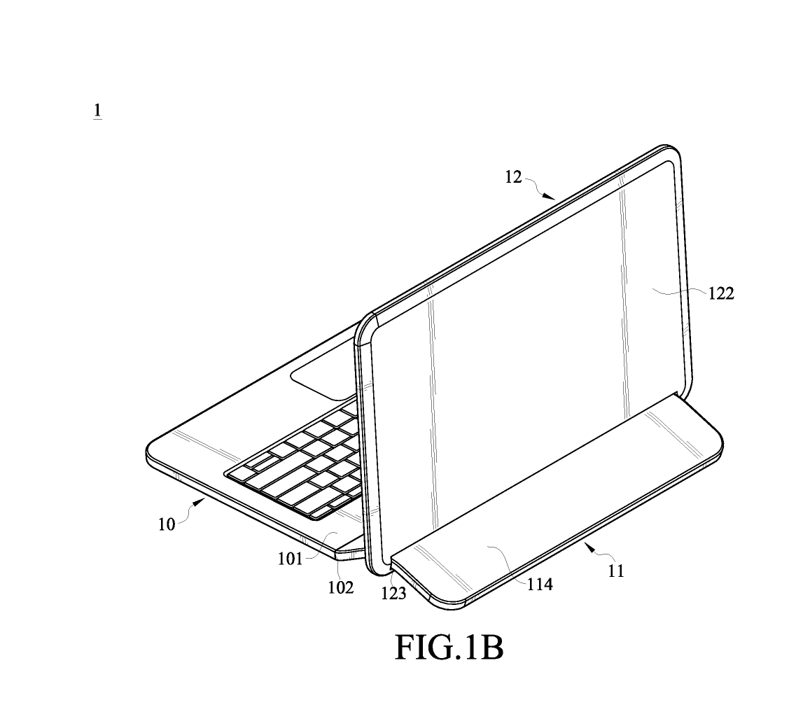

Please refer to FIG. 1A and FIG. 1B. FIG. 1A is a perspective front view of a detachable electronic device according to an embodiment of the disclosure. FIG. 1B is a perspective rear view of the detachable electronic device in FIG. 1A. In this embodiment, the detachable electronic device 1 comprises an input module 10, a flexible connecting module 11 and a display module 12.

As shown in FIG. 1, the input module 10 has a signal input part 101, a connection surface 102 and a magnetically attractable component 103. The connection surface 102 is located at a side of the signal input part 101. In this embodiment, the input module 10 is a keyboard. However, the input module 10 is not limited to a keyboard. In other embodiments, the input module 10, for example, is a touch input module.

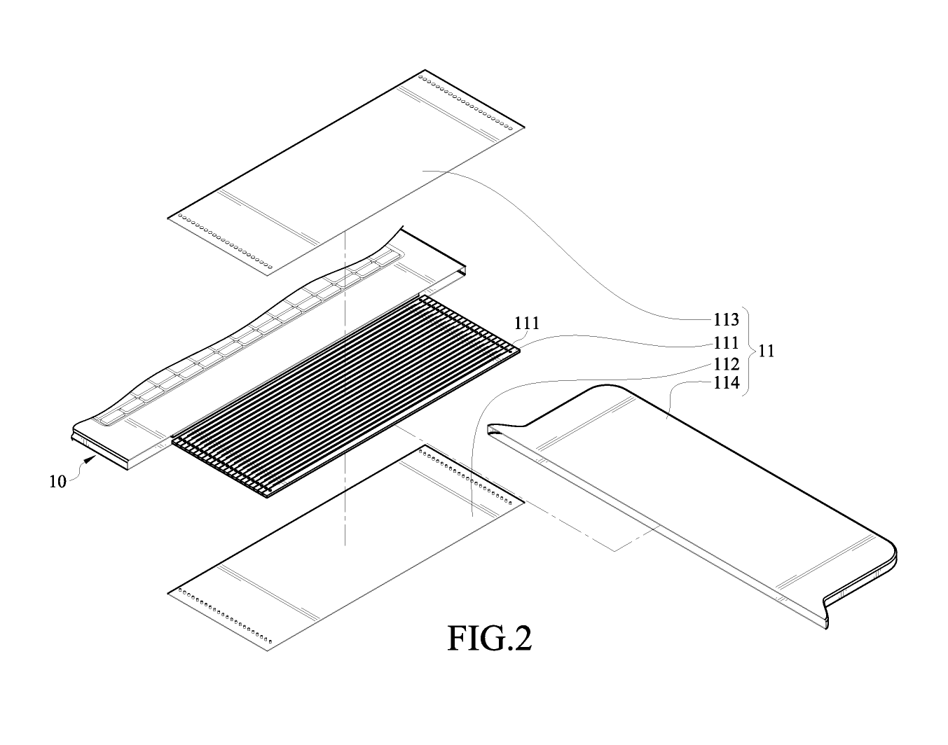

Please refer to FIG. 2 which is an exploded view of a flexible connecting module in FIG. 1A. As shown in FIG. 2, the flexible connecting module 11 is connected to the input module 10. In this embodiment, the flexible connecting module 11 comprises a plurality of assembly components 111, a first flexible component 112, a second flexible component 113 and a rubber cover 114. Each assembly component 111 is assembled with other assembly components 111, and one of the assembly components 111 is connected to the input module 10. Namely, the assembly components 111 are connected in sequence. Additionally, the assembly components 111 are made of plastic. Both the first flexible component 112 and the second flexible component 113 are assembled with the assembly components 111 and made of metal. Furthermore, the first flexible component 112, the second flexible component 113 and the assembly components 111 are enclosed by the rubber cover 114.

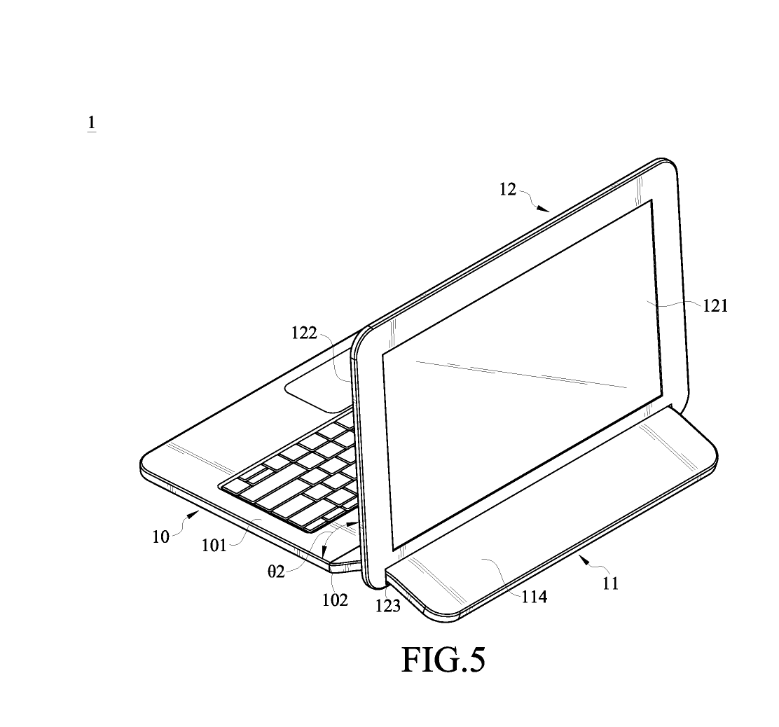

Please refer to FIG. 1A and FIG. 1B again, the display module 12 is electronically connected to the input module 10, and has a display part 121, a rear surface 122 and a slot 123. A first included angle θ1 is substantially formed between the display part 121 and the signal input part 101. In other words, the first included angle θ1 is a tilt angle of the display module 12 relative to the display module 12. The rear surface 122 faces opposite to the display part 121, and a second included angle θ2 (please refer to FIG. 5 in advance) is substantially formed between the rear surface 122 and the signal input part 101. The slot 123 is located at a peripheral of the display part 121, and extends through the display module 12 from the rear surface 122 to a side of the display module 12 having the display part 121. The flexible connecting module 11 is detachably assembled with the display module 12 by penetrating through the slot 123, and the flexible connecting module 11 is for supporting the display module 12. Additionally, the display module 12 further comprises a magnetic component 124. The magnetically attractable component 103 of the input module 10 is attracted by the magnetic component 124 of the display module 12. For example, the magnetic component 124 is a magnet, and the magnetically attractable component 103 is a metal, such as iron. In this embodiment, the display module 12 is a tablet computer, and the display part 121 is a touch screen.

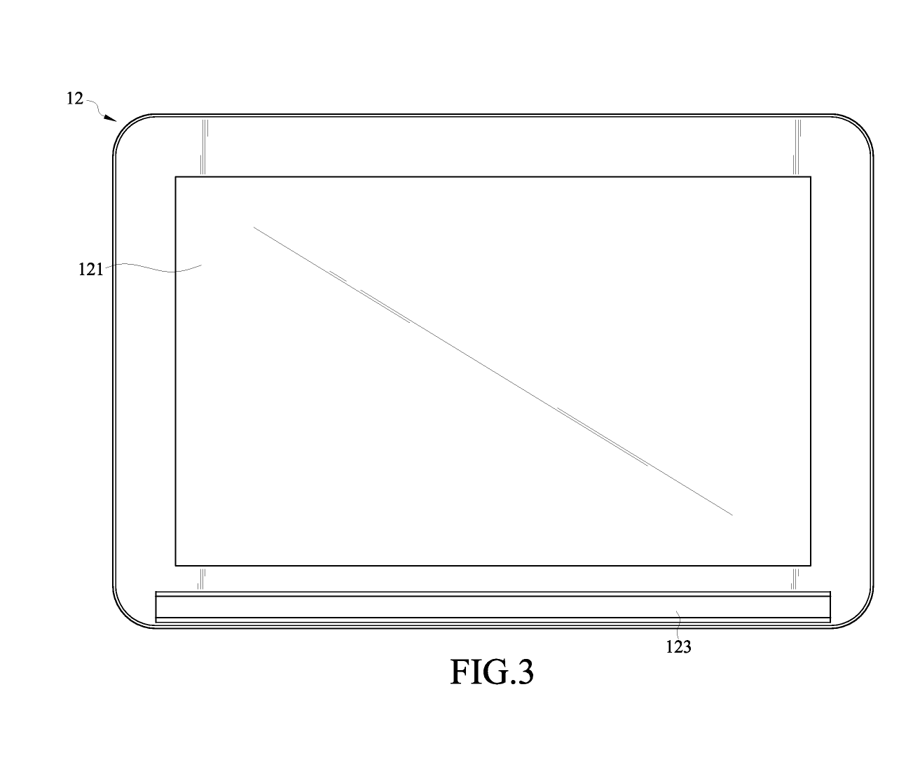

Each component of the detachable electronic device 1 is described as above-mentioned. Moreover, the configuration of the detachable electronic device 1 can be changed into different operation modes for users, such as a tablet mode, a laptop mode, a viewing mode, and a portable mode which are described as follows and shown in FIG. 3 through FIG. 6.

First, please refer to FIG. 3 which is a top view of the detachable electronic device when being in a tablet mode of operation. As shown in FIG. 3, and referring to FIG. 2 at the same time, since the display module 12 is the tablet computer in this embodiment, when the flexible connecting module 11 is separated from the slot 123 of the display module 12, the display module 12 can easily be held by a single hand of the users. Furthermore, the users can adjust the viewing angles of the display module 12 relative to the users, and also input at least one electronic signal via the display part 121. That is, the above-mentioned configuration is the tablet mode.

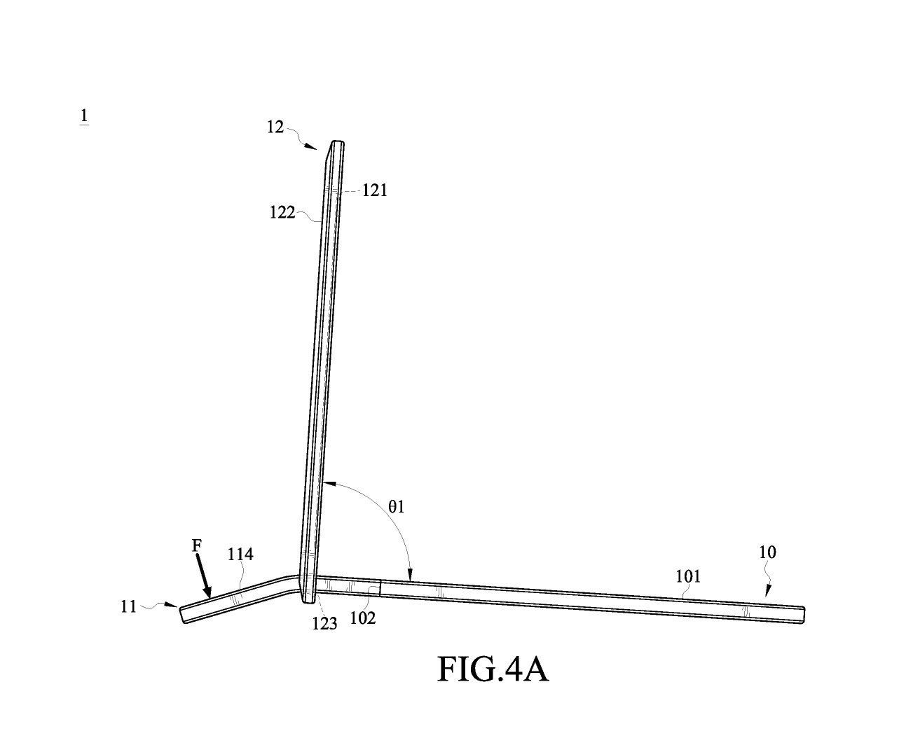

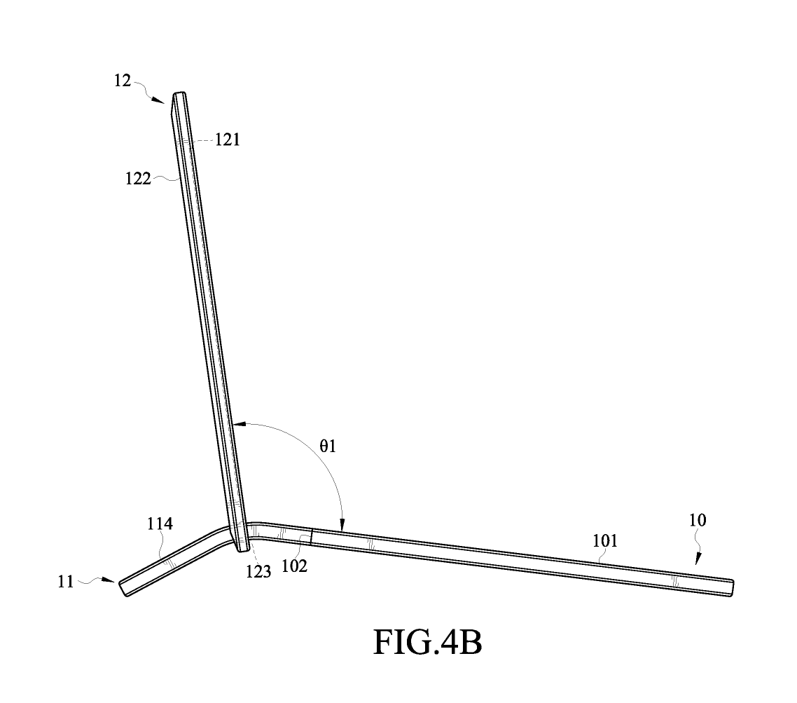

Then, please refer to FIG. 4A through FIG. 5. FIG. 4A and FIG. 4B are side views of the detachable electronic device when being in a laptop mode of operation. FIG. 5 is a perspective view of the detachable electronic device when being in a viewing mode of operation. The users can change the detachable electronic device 1 into the laptop mode or the viewing mode by assembling the flexible connecting module 11 with the display module 12 through the slot 123. Moreover, when the flexible connecting module 11 is assembled with the display module 12, whether the detachable electronic device 1 is in the laptop mode or in the viewing mode depends on the way the flexible connecting module 11 and the display module 12 are assembled.

As shown in FIG. 4A and FIG. 4B, when the flexible connecting module 11 penetrates the display module 12 via the slot 123 from the side of the display module 12 having the display part 121, the signal input part 101 of the input module 10 is located in front of the display part 121 of the display module 12. Accordingly, when the users view the display part 121, they also can input at least one electronic signal to the display module 12 by the input module 10 at the same time. That is, the above-mentioned configuration is the laptop module, and the detachable electronic device 1 is regarded as a laptop computer.

When the detachable electronic device 1 is in the laptop mode, the users can apply an external force F to the flexible connecting module 11 by bending it, to change a degree of the flexible connecting module 11. Thus, the flexible connecting module 11 is bent to be expanded relative to the input module 10 or moved toward the input module 10, thereby rotating the display module 12 relative to the input module 10 and changing the second included angle θ1 (i.e., the tilt angle of the display module 12 which is changed relative to the input module 10). In other words, the users can adjust the tilt angle of the display module 12 relative to the input module 10 according to their need, when the detachable electronic device 1 is in the laptop mode.

As shown in FIG. 5, when the users view the display part 121 of the display module 12 without using the input module 10, the flexible connecting module 11 can be driven to penetrate the display module 12 via the slot 123 from the rear surface 122 of the display module 12. At the same time, the input module 10 is located behind the display module 12. Accordingly, the users can focus on the display part 121 of the display module 12 and avoid inputting the electronic signal accidentally.

Similar to the laptop mode, when the detachable electronic device 1 is in the viewing mode, the users also can apply an external force (not shown in FIG. 5) to the flexible connecting module 11 by bending it, to change the degree of the flexible connecting module 11. Thus, the flexible connecting module 11 is bent to be expanded relative to the input module 10 or moved toward the input module 10, thereby rotating the display module 12 relative to the input module 10 and changing the second included angle θ2 (similar to the first included angle θ1, a tilt angle of the display module 12 which is changed relative to the input module 10). In other words, the users can adjust the tilt angle of the display module 12 relative to the input module 10 according to their need, when the detachable electronic device 1 is in the viewing mode.

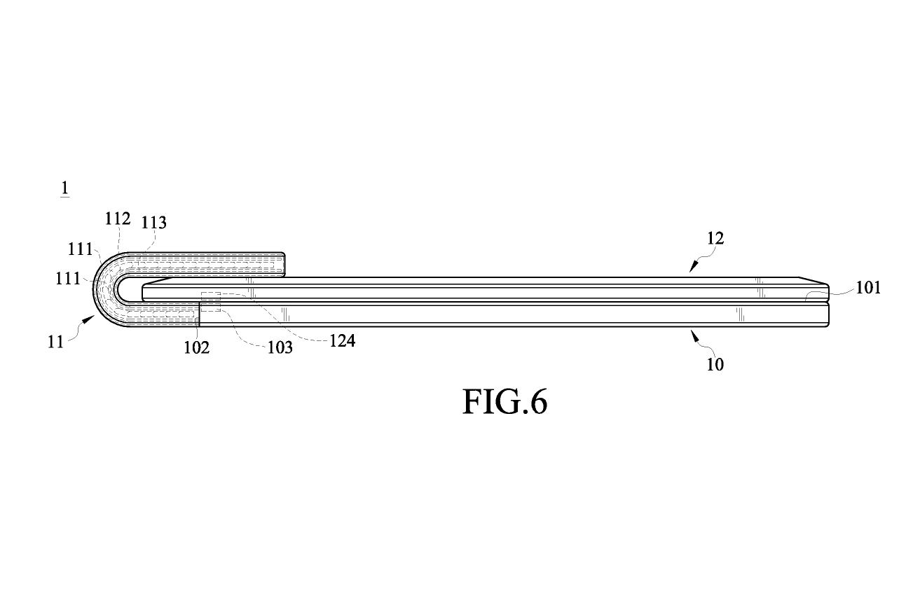

Please refer to FIG. 6, which is a side view of the detachable electronic device when being in a portable mode. After using the detachable electronic device 1, the users can change the detachable electronic device 1 into the portable mode from the laptop mode or the viewing mode. When the display module 12 is stacked on the input module 10, the magnetically attractable component 103 is magnetically attracted by the magnetic component 124 of the display module 12. Accordingly, the input module 10 is maintained to cover the display module 12, and prevented from moving relative to the display module 12 or separating from the display module 12.

Additionally, when the display module 12 is stacked on input module 10, the users can allow a part of flexible connecting module 11 to cover a part of display module 12. That is, this configuration is called the portable mode. At the same time, the display module 12 is maintained between the input module 10 and a part of flexible connecting module 11 (as shown in FIG. 6). In this embodiment, since both the materials of the first flexible component 112 and the second flexible component 113 are metal, the first flexible component 112 and the second flexible component 113 can be attracted by the magnetic component 124, such that the part of flexible connecting module 11 covers the part of display module 12. Thus, the users can hold the flexible connecting module 11 to carry all the detachable electronic device 1 around with them at the same time.

To sum up, according to the detachable electronic device of the disclosure, the detachable electronic device comprises the flexible connecting module and the display module, and the flexible connecting module can be detachably assembled with the display module by penetrating through the slot of the display module. Accordingly, the configuration of the detachable electronic device can be changed into the tablet mode, the laptop mode, the viewing mode or the potable mode, which are provided to the users variably.

The disclosure will become more fully understood from the said embodiments for illustration only and thus does not limit the disclosure. Any modifications within the spirit and category of the disclosure fall in the scope of the disclosure.

What is claimed is:

1. A detachable electronic device, comprising:
an input module having a signal input part;
a flexible connecting module connected to the input module; and
a display module electrically connected to the input module and having a display part and a slot, the slot being located at a peripheral of the display part, the flexible connecting module being detachably assembled with the display module via the slot, and for supporting the display module;
wherein, when the flexible connecting module is bent by an external force, the display module is driven to rotate relative to the input module, and a tilt angle of the display module is changed relative to the input module.

2. The detachable electronic device according to claim 1, wherein the input module further has a connection surface located at a side of the signal input part and connected to the flexible connecting module.

3. The detachable electronic device according to claim 1, wherein the flexible connecting module is for being bent by the external force to be expanded relative to the input module or moved toward the input module.

4. The detachable electronic device according to claim 1, wherein the display module comprises a magnetic component, the input module comprises a magnetically attractable component, and when the display module is stacked on the input module, the magnetically attractable component is attracted by the magnetic component.

5. The detachable electronic device according to claim 4, wherein when the display module is stacked on the input module, a part of the flexible connecting module covers a part of the display module, and the display module is maintained between the input module and the part of the flexible connecting module.

6. The detachable electronic device according to claim 1, wherein the flexible connecting module comprises a plurality of assembly components and a first flexible component, each assembly component is assembled with other assembly components, one of the assembly components is connected to the input module, and the first flexible component is assembled with the plurality of assembly components.

7. The detachable electronic device according to claim 6, wherein the flexible connecting module further comprises a second flexible component assembled with the plurality of assembly components, and the plurality of assembly components is located between the first flexible component and the second flexible component.

8. The detachable electronic device according to claim 7, wherein the first flexible component and the second flexible component are made of metal, and the plurality of assembly components are made of plastic.

9. The detachable electronic device according to claim 7, wherein the flexible connecting module further comprises a rubber cover, and the first flexible component, the second flexible component and the plurality of assembly components are enclosed by the rubber cover.

10. The detachable electronic device according to claim 1, wherein the display module is a tablet computer.
